(19) United States
(12) Patent Application Publication
(10) Pub. No.: US 2013/0016531 A1
(43) Pub. Date: Jan. 17, 2013

(54) POWER SUPPLY DEVICE AND METHOD OF CONTROLLING POWER SUPPLY DEVICE

(71) Applicant: Shinji ASO, Niiza-shi (JP)

(72) Inventor: Shinji ASO, Niiza-shi (JP)

(73) Assignee: Sanken Electric Co., Ltd., Niiza-shi (JP)

(21) Appl. No.: 13/540,106

(22) Filed: Jul. 2, 2012

(30) Foreign Application Priority Data
Jul. 13, 2011 (JP) 2011-154723

(51) Int. Cl. H02M 3/335

(52) U.S. Cl. 363/16

(57) ABSTRACT

The present invention includes: a power factor correction circuit configured to correct a power factor; a DC/DC converter configured to convert an output voltage of the power factor correction circuit to a different direct-current voltage; an input voltage detector configured to detect an input voltage inputted into the power factor correction circuit; and a power factor correction circuit output voltage controller configured to generate a voltage instruction for controlling the output voltage of the power factor correction circuit, based on a value of the detected input voltage, an output current value to a load connected to an output of the DC/DC converter or an output power value of the load, as well as a set value of an input voltage short break output hold time, and to output the voltage instruction to the power factor correction circuit.

### TECHNICAL FIELD

The present invention relates to a power supply device including a PFC (power factor correction) circuit and a method of controlling the power supply device.

### BACKGROUND ART

FIG. 1 is a diagram showing a configuration of a conventional general power supply device. The power supply device includes: a diode bridge DB configured to rectify an alternating current inputted from a commercial alternating-current power supply AC via a filter F; a PFC circuit 2a configured to correct a power factor by processing an output of the diode bridge DB; and a DC/DC converter 3 configured to convert an output voltage of the PFC circuit 2a to a different direct-current voltage.

The PFC circuit 2a has a step-up circuit and includes: a series circuit connected between a positive electrode and a negative electrode of the diode bridge DB and including a reactor L1 and a switching element Q1 formed of a MOSFET; a series circuit including a diode D1 and a capacitor C1, the diode D1 having an anode connected to a connection point between the reactor L2 and the switching element Q1, the capacitor C1 having one end connected to a cathode of the diode D1 and the other end connected to the negative electrode of the diode bridge DB; and a PFC controller 21a.

The PFC controller 21a obtains an error voltage by comparing the output voltage (voltage at both ends of the capacitor C1) of the PFC circuit 2a and a reference voltage with each other. Then, the PFC controller 21a generates a control signal switching on and off at a pulse width according to the error voltage and outputs the control signal to a gate of the switching element Q1. The switching element Q1 turns on and off according to the pulse width of the control signal to control the output voltage of the PFC circuit 2a to a predetermined voltage.

The DC/DC converter 3 includes a full bridge circuit 31, a transformer T1, diodes D2 and D3, a reactor L2, a capacitor C2, an error amplifier 32, and a DC/DC controller 33.

The full bridge circuit 31 is formed of MOSFETs Q2, Q3, Q4, and Q5. Both ends of the capacitor C1 are connected respectively to a connection point between the MOSFET Q2 and the MOSFET Q4 and a connection point between the MOSFET Q3 and the MOSFET Q5. The DC/DC controller 33 outputs a control signal to gates of the respective MOSFETs Q2, Q3, Q4, and Q5. Each of the MOSFETs Q2, Q3, Q4, and Q5 is turned on and off according to the control signal. A connection point between the MOSFET Q2 and the MOSFET Q3 and a connection point between the MOSFET Q4 and the MOSFET Q5 are connected respectively to both ends of a primary winding P of the transformer T1.

A rectifying-smoothing circuit formed of the diodes D2 and D3, the reactor L2, and the capacitor C2 is connected to a first secondary winding S1 and a second secondary winding S2 of the transformer T1. One end of the first secondary winding S1 is connected to an anode of the diode D2 and the other end thereof is connected one end of the second secondary winding S2. The cathode of the diode D2 is connected to one end of the reactor L2. The other end of the second secondary winding S2 is connected to an anode of the diode D3 and a cathode of the diode D3 is connected to the one end of the reactor L2 and the cathode of the diode D2.

The other end of the reactor L2 is connected to one end of the capacitor C2 and the other end of the capacitor C2 is connected to a connection point between the first secondary winding S1 and the second secondary winding S2. Both ends of the capacitor C2 are connected to output terminals of the DC/DC converter 3.

An error amplifier 32 calculates an error voltage by comparing the output voltage outputted from the DC/DC converter and the reference voltage with each other. The DC/DC controller 33 generates a PWM control signal switching on and off at a pulse width according to the error voltage from the error amplifier 32 and outputs the PWM control signal to gates of the respective MOSFETs Q2, Q3, Q4, and Q5.

In such a power supply device, the PFC circuit can operate at a higher efficiency when the step-up ratio is smaller. Incidentally, the output voltage of the PFC circuit is controlled to a voltage higher than a peak value of an upper limit of an input voltage range and the PFC circuit rarely operates at the upper limit of the input voltage range in a steady state. For example, the PFC circuit operates at an alternating-current voltage of about 230 V even when the input voltage range is AC 180 V to 265 V, and the PFC circuit is generally operated with the output voltage of 265×√2=375 V, or about 380 V to 390 V, based on the upper limit value of the input voltage range. However, since the input alternating-current voltage is about 230 V in a normal state, higher efficiency is achieved when the output voltage of the PFC circuit is controlled to 230 V×√2=325 V, or about 330 V to 340 V.

Moreover, the power supply device needs to stably supply power to the load device for a predetermined time even when a short power failure occurs in the commercial alternating-current power supply AC. Hence, when the amount of power used by the load device is unknown, in order for the PFC circuit to operate with the output voltage of 330V, the minimum control input voltage of the DC/DC converter needs to be set to a small value to satisfy a hold time at the maximum power. This increases the control range of the input voltage of the DC/DC converter and the efficiency of the DC/DC converter is thereby deteriorated. Hence, the power supply device as a whole cannot achieve high efficiency.

As the related art, Japanese Patent Application Publication No. 2011-114917 discloses a switching power supply device in which a loss in a DC/DC converter unit is reduced and the efficiency is thereby drastically improved compared to the conventional cases. This switching power supply device includes: a rectifying-smoothing unit configured to rectify and smooth an alternating-current voltage supplied from the outside; and a power factor correction unit provided on an output side of the rectifying-smoothing unit and configured to correct the power factor; and a DC/DC converter unit configured to convert the output of the power factor correction unit to a predetermined direct-current voltage. The power factor correction unit is feedback-controlled based on a direct-current component of a secondary-side output voltage. The DC/DC converter unit is a bidirectional DC/DC converter capable of stepping up and down a voltage and is feedback-controlled based on an alternating-current component of the secondary-side output voltage.

As described above, the PFC circuit can operate at higher efficiency when the step-up ratio is smaller. However, the efficiency is deteriorated since, while the PFC circuit operates at an approximately rated input voltage for the most of the time in a normal operation, the output voltage of the PFC circuit is controlled to a voltage higher than a peak value of the upper limit of the input voltage range. Moreover, the efficiency is deteriorated when the load is light.

### SUMMARY OF INVENTION

An object of the present invention is to provide a power supply device capable of operating at high efficiency and a method for controlling the power supply device.

A power supply device of the present invention comprises a power factor correction circuit configured to correct a power factor; a DC/DC converter configured to convert an output voltage of the power factor correction circuit to a different direct-current voltage; an input voltage detector configured to detect an input voltage inputted into the power factor correction circuit; and a power factor correction circuit output voltage controller configured to generate a voltage instruction for controlling the output voltage of the power factor correction circuit, based on an input voltage value detected by the input voltage detector, any of an output current value to a load connected to an output of the DC/DC converter and an output power value from the load, as well as a set value of an input voltage short break output hold time, and to output the voltage instruction to the power factor correction circuit.

### BRIEF DESCRIPTION OF DRAWINGS

FIG. 1 is a diagram for explaining a conventional power supply device.

FIG. 2 is a block diagram showing a configuration of a power supply device of Embodiment 1 of the present invention.

FIG. 3 is a flowchart showing an operation of a PFC output voltage controller in the power supply device of Embodiment 1 of the present invention.

FIG. 4 is a circuit diagram showing details of an input voltage detector and a PFC circuit in the power supply device of Embodiment 1 of the present invention.

FIG. 5 is a circuit diagram showing a detailed configuration of a power supply device of Embodiment 1 of the present invention.

FIG. 6 is a block diagram showing a configuration of a power supply device of Embodiment 2 of the present invention.

### DESCRIPTION OF EMBODIMENTS

Detailed descriptions are given below of a power supply device of embodiments of the present invention and a method of controlling the power supply device, with reference to the drawings.

The power supply device of the present invention includes a PFC circuit which corrects a power factor and a DC/DC converter which converts an output voltage of the PFC circuit to a different direct-current voltage and outputs the direct-current voltage. The power supply device which can operate at high efficiency in a wide load range can be achieved by controlling the output voltage of the PFC circuit based on an input voltage, an output current or an output power, as well as a set value of an input voltage short break output hold time.

The input voltage short break output hold time is also called output voltage hold time or output hold time. The input voltage short break output hold time is a guaranteed time in which the power supply device can supply a stable output voltage to a load when a power supply from a commercial alternating-current power supply AC to the power supply device is cut, and is one of specification and standard items of the power supply device.

Moreover, the present invention determines the output voltage of the PFC circuit from a PFC output voltage instruction generated based on the input voltage and the output current or on the output power and the set value of the input voltage short break output hold time. Values detected inside the power supply device are used as the input voltage and the output current. The set value of the input voltage short break output hold time and a value of a minimum control input voltage of the DC/DC converter are stored in the power supply device in advance. This achieves high efficiency during the operation of the power supply device.

Furthermore, when the output of the power supply device is used by a load device being a different device, there is a case where specifications such as the input voltage short break output hold time are different between the devices. The load device and the power supply device thus may have a communication function of transmitting and receiving information such as the input voltage short break output hold time to secure versatility of the power supply device.

In this case, the power supply device can receive information on a required amount of power from the load device. When the used amount of power of the load device fluctuates largely (an output current fluctuation from the view point of the power supply device), the adequate control of the power supply device in consideration of the input voltage short break output hold time is made possible by transmitting information on the assumed amount of power to the power supply device. The power supply device is thus configured which is capable of operating at high efficiency in a wide load range while maintaining reliability such as the input voltage short break output hold time.

In the power supply device of the present invention, the output voltage of the PFC circuit is controlled in consideration of the set value of the input voltage short break output hold time in addition to the output current detected in the power supply device and the information on used power which is obtained from the load device. Hence, the high efficiency state due to the output voltage of the PFC circuit is maintained without the efficiency of the DC/DC converter being reduced and the efficiency of the power supply device as a whole can be improved to the highest level. Moreover, it is possible not only to control the output voltage of the PFC circuit but also to reduce the operating frequency and the power supply device can be thus made more efficient.

For example, assume a case where, in a conventional power supply device which is formed of a PFC circuit and a full bridge forward converter (hereafter, referred to as FB converter) and which is capable of outputting a power of 600 W, the output voltage of the PFC circuit is controlled to 390 V (constant), a capacity C of an electrolysis condenser provided on the output side of the PFC circuit is 270 μF, and an input voltage short break output hold time Th is 20 ms (set value). In this case, a minimum input voltage Vmin of the FB converter is 250 V. Accordingly, the on-duty of the FB converter in a steady state is 32%. Even when the input voltage is AC 230 V and the load is 50%, the output voltage of the PFC circuit is 390 V and the step-up ratio of the PFC circuit is (390/322)=1.21 and the on-duty of the FB converter is 32%.

On the contrary, the power supply device of the present invention controls the output voltage of the PFC circuit based on the input voltage and the output current or the amount of power, by using the smallest value which satisfies the following conditions:

(1) equal to or greater than the peak voltage of the input voltage
(2) equal to or greater than the voltage guaranteeing the set value of the input voltage short break output hold time.

Output voltage V_{PFC} of PFC circuit>√((2×Po×Th)/C+Vmin²)

For example, when the input voltage is AC 230 V and the load is 50%, an instruction value of the output voltage of the PFC circuit satisfies the following conditions:

(1) peak voltage of input voltage=230×1.4=322 V or larger
(2) √((2×Po×Th)/C+Vmin²)=√((2×300×20e−3)/270e−6+250²)32 327 or larger.
Accordingly, the instruction value of the PFC output voltage instruction is 327 V. Hence, the step-up ratio of the PFC circuit is (327 V/322 V)=1.02 and the on-duty of the FB converter is 38%. The efficiency is improved by the reduction of the step-up ratio of the PFC circuit and also by the increase in on-duty of the FB converter. The efficiency in a light load of 50% or less is thereby drastically improved.

When the power to be converted is the same, the peak value becomes larger as the duty ratio becomes smaller, although the mean value of a current flowing through a switch and windings remains the same. Accordingly, an effective value becomes larger. Since a loss due to resistances of the switch and the windings is equal to a square of an effective current multiplied by a resistance component, the loss becomes larger as the effective current becomes larger and the efficiency thereby is deteriorated. In other words, when the power to be converted is the same, a larger duty ratio reduces the effective current, thereby reducing the loss and improving the efficiency.

### Embodiment 1

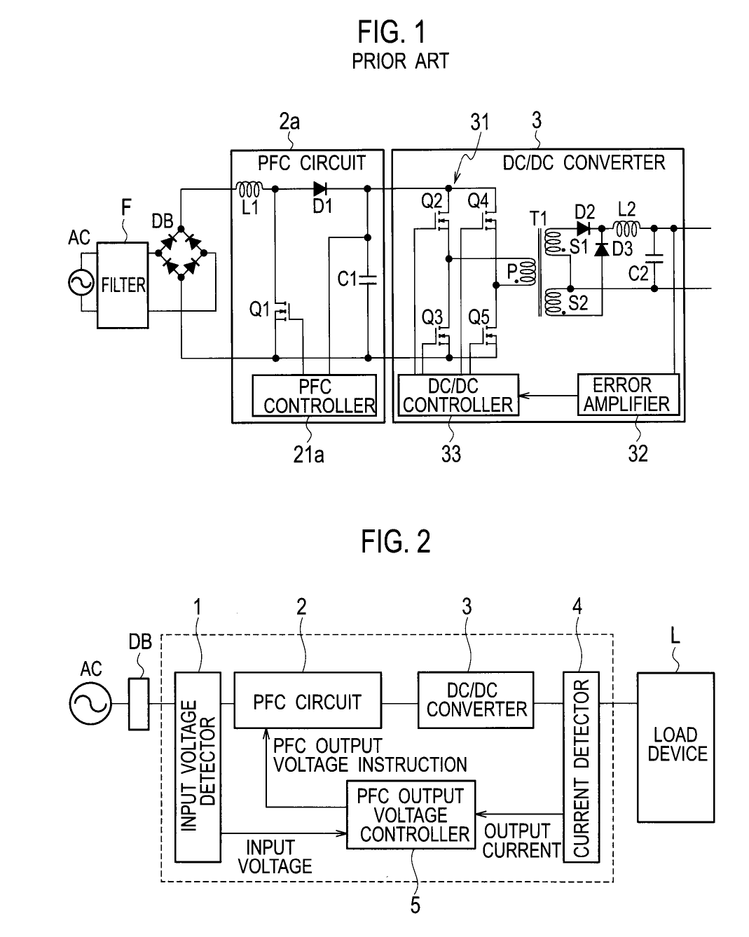

FIG. 2 is a block diagram showing a configuration of a power supply device of Embodiment 1 of the present invention. In FIG. 2, the same parts as those of the conventional power supply device shown in FIG. 1 are denoted by the same reference numerals and described.

The power supply device includes an input voltage detector 1, a PFC circuit 2 configured to correct a power factor, a DC/DC converter 3 configured to convert an output voltage of the PFC circuit 2 into a different direct-current voltage and to output the direct-current voltage, a current detector 4, and an PFC output voltage controller 5.

The input voltage detector 1 detects a voltage sent from a commercial alternating-current power supply AC via a diode bridge DB and outputs the voltage to the PFC output voltage controller 5. The details of the input voltage detector 1 are described later. Moreover, the voltage inputted into the input voltage detector 1 is outputted to the PFC circuit 2 via the input voltage detector 1.

The PFC circuit 2 is a circuit configured to correct the power factor. The PFC circuit 2 changes a voltage sent from the commercial alternating-current power supply AC via the diode bridge DB and the input voltage detector 1, according to a PFC output voltage instruction from the PFC output voltage controller 5, and output the voltage to the DC/DC converter 3. The details of the PFC circuit 2 are described later.

The DC/DC converter 3 converts the output voltage of the PFC circuit 2 into the different direct-current voltage and outputs the direct-current voltage to the current detector 4. The DC/DC converter 3 is the same as one shown in FIG. 1 and the description thereof is thereby omitted.

The current detector 4 sends the output of the DC/DC converter 3 to a load device L. Furthermore, the current detector 4 detects a current flowing in the load device L and outputs the detected current to the PFC output voltage controller 5 as an output current.

The PFC output voltage controller 5 corresponds to a power factor correction circuit output voltage controller. The PFC output voltage controller 5 generates the PFC output voltage instruction based on an input voltage value from the input voltage detector 1, an output current value from the current detector 4, and a set value of an input voltage short break output hold time stored in a RAM (not shown) provided in the PFC output voltage controller 5, and outputs the PFC output voltage instruction to the PFC circuit 2. The PFC circuit 2 generates an output voltage according to the PFC output voltage instruction and outputs the output voltage to the DC/DC converter 3.

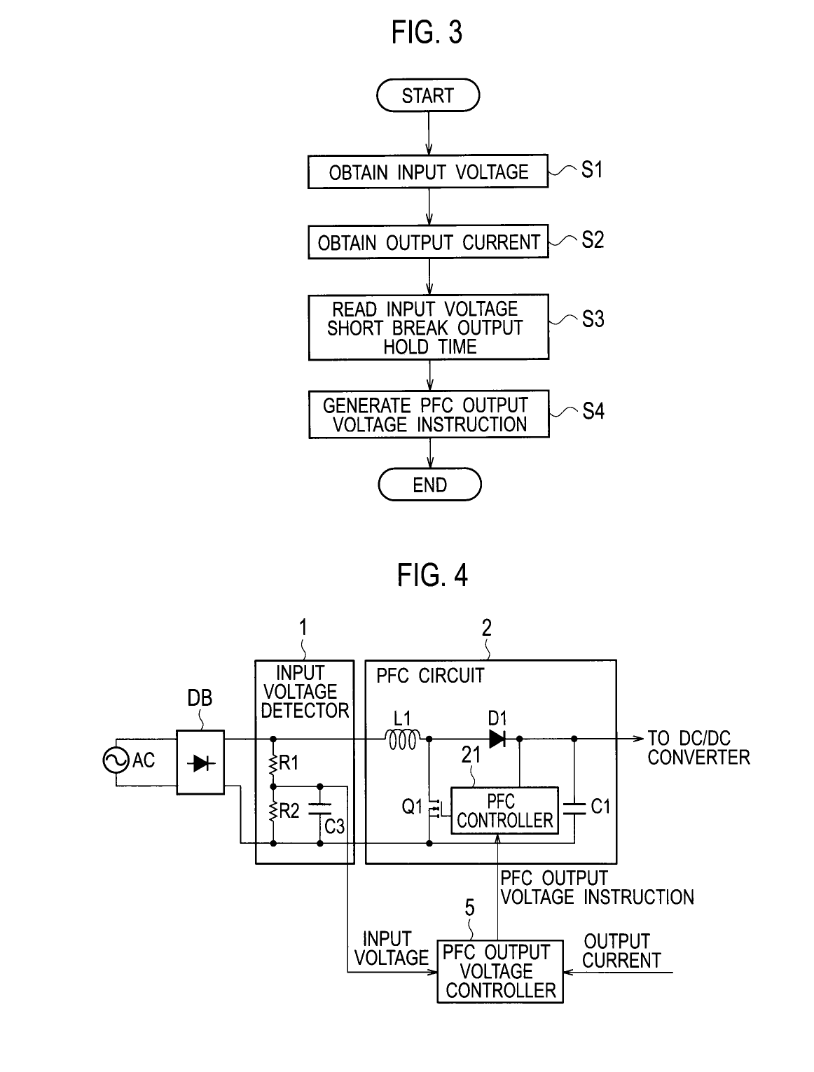

FIG. 3 is a flowchart showing details of a PFC output voltage instruction generating process performed by the PFC output voltage controller 5. In the PFC output voltage instruction generating process, the PFC output voltage controller 5 first obtains the input voltage value from the input voltage detector 1 (step S1).

Then, the PFC output voltage controller 5 obtains the output current value from the current detector 4 (step S2). Furthermore, the PFC output voltage controller 5 obtains the set value of the input voltage short break output hold time from the RAM provided inside itself (step S3).

Thereafter, the PFC output voltage controller 5 generates the PFC output voltage instruction based on the input voltage value obtained in step Si, the output current value obtained in step S2, and the set value of the input voltage short break output hold time obtained in step S3 (step S4) and outputs the PFC output voltage instruction to the PFC circuit 2. The PFC circuit 2 thereby generates the output voltage according to the instruction value indicated by the PFC output voltage instruction and outputs the output voltage to the DC/DC converter 3.

Next, the details of the input voltage detector 1 and the PFC circuit 2 are described. FIG. 4 is a circuit diagram extracting and showing in detail only the input voltage detector 1 and the PFC circuit 2.

The input voltage detector 1 is formed of: resistances R1 and R2 connected serially between output terminals of the diode bridge DB; and a capacitor C3 whose one end is connected to a connection point between the resistances R1 and R2 and whose other end is connected to a negative electrode of the diode bridge DB. A voltage at the connection point between the resistances R1 and R2, i.e. a voltage divided by the resistances R1 and R2, is outputted from the input voltage detector 1 to the PFC output voltage controller 5 as the input voltage. Moreover, a voltage inputted from the diode bridge DB to the input voltage detector 1 is outputted to the PFC circuit 2 via the input voltage detector 1.

The PFC circuit 2 has a step-up circuit and includes: a series circuit formed of a reactor L1 and a switching element Q1 connected between a positive electrode and the negative electrode of the diode bridge DB; a series circuit formed of a diode D1 and a capacitor C1, the diode D1 having an anode connected to a connection point between the reactor L1 and the switching element Q1, the capacitor C1 having one end connected to a cathode of the diode D1 and the other end connected to the negative electrode of the diode bridge DB; and a PFC controller 21.

The PFC controller 21 obtains an error voltage by comparing the output voltage (voltage at both ends of the capacitor C1) of the PFC circuit 2 and the voltage value indicated by the instruction value of the PFC output voltage instruction sent from the PFC output voltage controller 5 with each other. Then, the PFC controller 21 generates a control signal switching on and off at a pulse width according to the obtained error voltage and outputs the control signal to a gate of the switching element Q1. The switching element Q1 is thereby turned on and off according to the pulse width of the control signal.

Specifically, the PFC controller 21 controls the switching element Q1 in such a way that the current of the commercial alternating-current power supply AC becomes a sine wave and that the output voltage approaches the voltage value indicated by the instruction value of the PFC output voltage instruction from the PFC output voltage controller 5. The PFC output voltage controller 5 outputs a larger one of an input voltage Vin (Peak) obtained from the input voltage detector 1 and a voltage calculated from Formula (1) described below to the PFC controller 21 as the instruction value of the PFC output voltage instruction, the voltage being calculated from Formula (1) by using the output current Io obtained from the current detector 4 as well as the output voltage Vo, the minimum input voltage Vmin of the DC/DC converter 3, the input voltage short break output hold time Th, and the capacity C of the capacitor C1 of the PFC circuit which are stored in advance. The PFC controller 21 can thereby control the output voltage of the PFC circuit 2 to the voltage value indicated by the instruction value of the PFC output voltage instruction.

√((2×Vo×Io×Th)/C+Vmin²) (1)

The condition shown in Formula (1) is theoretically satisfactory for the voltage value indicated by the instruction value of the PFC output voltage instruction. However, in a practical use, it is preferable to provide a margin of, for example, about 10% and output a larger one of a voltage calculated from Formula (2) described below and the input voltage Vin (Peak)×1.1 to the PFC controller 21 as an instruction value of the PFC output voltage instruction.

√((2×Vo×Io×Th)/C+Vmin²)×1.1 (2)

Moreover, accuracy can be improved by storing efficiency characteristics of the power supply device in the PFC output voltage controller 5 in advance and introducing the efficiency characteristics into Formula (1).

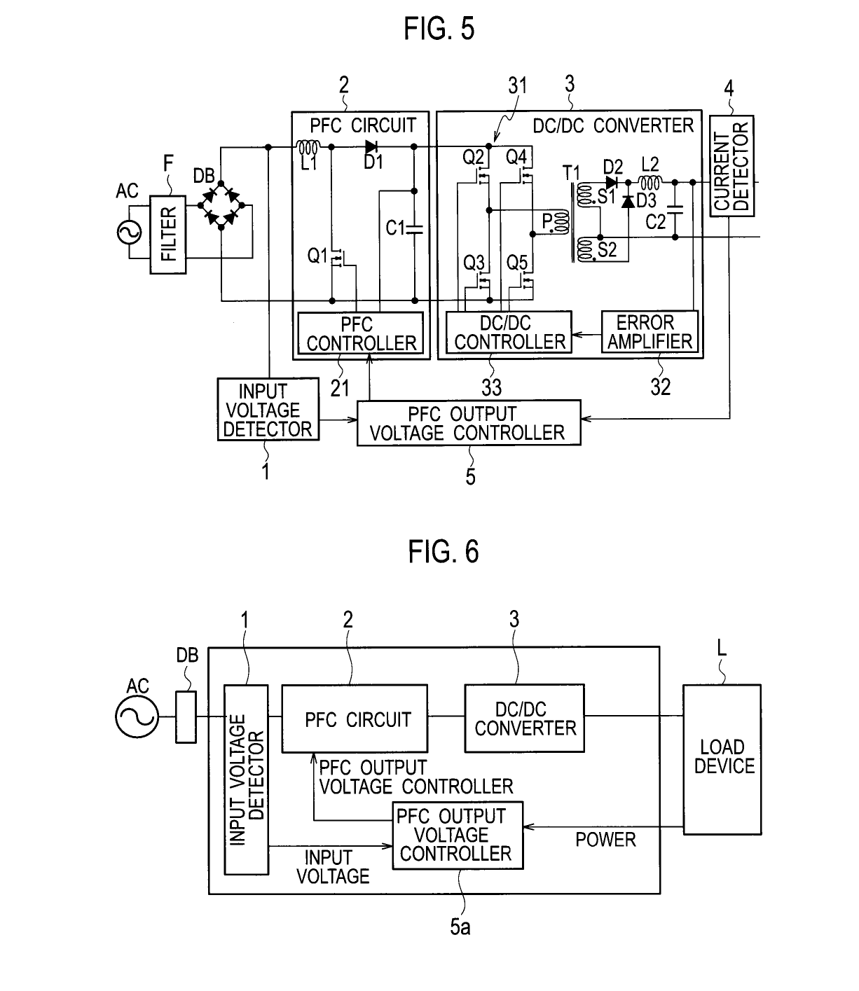

FIG. 5 is a circuit diagram showing a detailed configuration of the entire power supply device of Embodiment 1. The circuit diagram of FIG. 5 is a diagram made by integrating the contents of FIGS. 2, 4, and 1. Since the contents of these figures have been already described, the descriptions thereof are omitted herein.

### Embodiment 2

A power supply device of Embodiment 2 of the present invention is characterized in that a power supply device obtains information corresponding to an output current from a load device and performs a control similar to that of the power supply device of Embodiment 1.

FIG. 6 is a block diagram showing a configuration of the power supply device of Embodiment 2 of the present invention. This power supply device is characterized in that the current detector 4 is eliminated from the power supply device of Embodiment 1 shown in FIG. 2 and the power supply device obtains a power from a load device L instead of the output current obtained from the current detector 4. Specifically, a portion of “Vo×Io” in Formulae (1) and (2) is obtained from a load device L.

When a micro computer or the like, for example, is mounted on the load device L and there is a possibility of the output current of the power supply device increasing and decreasing, the power supply device has such an advantage that a set value of the input voltage short break output hold time can be set to an appropriate value by causing the load device L to transmit information on the power to the power supply device in advance, in consideration of the increase and decrease of the output current.

Moreover, configuring the load device L to transmit the input voltage short break output hold time Th in addition to the power information (Vo×Io) enables optimal control and the power supply device capable of operating at a higher efficiency can be achieved.

In the power supply devices of the present invention, the power factor correction circuit output voltage controller controls the output voltage of the power factor correction circuit based on the input voltage value, the output current value or the output power value, as well as the set value of the input voltage short break output hold time. Accordingly, the power supply device capable of operating at high efficiency can be provided.

### Industrial Applicability

The present invention can be applied to a power supply device which is required to be operated at high efficiency.

What is claimed is:

1. A power supply device comprising:
a power factor correction circuit configured to correct a power factor;
a DC/DC converter configured to convert an output voltage of the power factor correction circuit to a different direct-current voltage;
an input voltage detector configured to detect an input voltage inputted into the power factor correction circuit; and
a power factor correction circuit output voltage controller configured to generate a voltage instruction for controlling the output voltage of the power factor correction circuit, based on an input voltage value detected by the input voltage detector, any of an output current value to a load connected to an output of the DC/DC converter and an output power value from the load, as well as a set value of an input voltage short break output hold time, and to output the voltage instruction to the power factor correction circuit.

2. The power supply device according to claim 1, wherein the power factor correction circuit output voltage controller generates the voltage instruction in such a way that the output voltage of the power factor correction circuit is controlled to be the smallest value which is equal to or greater than the input voltage value detected by the input voltage detector and which is equal to or greater than a voltage value guaranteeing the set value of the input voltage short break output hold time.

3. The power supply device according to claim 1, wherein the set value of the input voltage short break output hold time is a value stored in the power supply device in advance or a value inputted from the load outside the power supply device.

4. The power supply device according to claim 2, wherein the set value of the input voltage short break output hold time is a value stored in the power supply device in advance or a value inputted from the load outside the power supply device.

5. A method of controlling a power supply device including a power factor correction circuit configured to correct a power factor and a DC/DC converter configured to convert an output voltage of the power factor correction circuit to a different direct-current voltage, the method comprising:
an input voltage detection step of detecting an input voltage inputted into the power factor correction circuit;
a power factor correction circuit output voltage control step of generating a voltage instruction for controlling the output voltage of the power factor correction circuit, based on an input voltage value detected by the input voltage detector, any of an output current value to a load connected to an output of the DC/DC converter and an output power value from the load, as well as a set value of an input voltage short break output hold time, and outputting the voltage instruction to the power factor correction circuit.
